(19) United States
(12) Patent Application Publication
(10) Pub. No.: US 2009/0125190 A1
(43) Pub. Date: May 14, 2009

(54) Power Steering Apparatus

(75) Inventors: Tatsuo Matsumura, Atsugi-shi (JP); Mitsuo Sasaki, Hadano-shi (JP); Toru Takahashi, Hiratsuka-shi (JP); Kohei Ono, Nagoya-shi (JP); Eiji Kasai, Toyota-shi (JP); Takatoshi Saito, Toyota-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi, Ltd.; Toyota Jidosha Kabushiki Kaisha

(21) Appl. No.: 12/269,175

(22) Filed: Nov. 12, 2008

(30) Foreign Application Priority Data
Nov. 12, 2007 (JP) 2007-292792

(51) Int. Cl. B62D 5/06; B62D 6/00

(52) U.S. Cl. 701/42; 180/422

(57) ABSTRACT

A power steering apparatus includes a power cylinder including first and second pressure chambers; a reversible pump including a first outlet port and a second outlet port; a first hydraulic passage including a portion made from an elastomer; a second hydraulic passage including a portion made from an elastomer; a motor arranged to drive the reversible pump; a motor control section; a pump reverse rotation judging section configured to judge a reverse rotation state of the reversible pump when an actual rotation direction of the reversible pump does not correspond to a direction in which the motor is rotated by the driving signal from the motor control section; and a damping torque adding section configured to damp a torque generated in the reversible pump when the pump reverse rotation judging section determines the reverse rotation state of the reversible pump.

### BACKGROUND OF THE INVENTION

This invention relates to a hydraulic power steering apparatus.

U.S. Pat. No. 7,174,988 (corresponding to Japanese Patent Application Publication No. 2005-47296) shows a power steering apparatus including a motor; a power cylinder having left and right pressure chambers; and a reversible pump driven by the motor, and arranged to supply a fluid pressure selectively to the left and right pressure chambers to obtain a steering assist force. The reversible pump and the power cylinder are connected by steel pipes. A synthetic rubber pipe is used in a portion in which the steel pipe is not used due to layout of the vehicle.

### SUMMARY OF THE INVENTION

In this power steering apparatus, when the hands are released from the steering handle (in a hand free state) after the steering handle is further steered from a handle abutting state, the steering handle is not converged, and the hunting is generated. That is, when the steering handle is further steered from the handle abutting state, the synthetic rubber pipe on the pressurized side is inflated by the pressure increase within the pipe. Then, when the hands are released from the steering handle, the inflated synthetic resin rubber pipe is contracted, and the hydraulic fluid within the pipe is reversed to the reversible pump. This flow of the hydraulic fluid is acted to the power cylinder, and the driver feels the unnatural feeling to the handle.

It is, therefore, an object of the present invention to provide a power steering apparatus devised to solve the above mentioned problem, to avoid hunting in a hand free state, and to decrease an unnatural feeling.

According to one aspect of the present invention, a power steering apparatus comprises: a power cylinder including first and second pressure chambers, the power cylinder being arranged to assist a steering force of a steering mechanism connected with steered wheels; a reversible pump including a first outlet port and a second outlet port, the reversible pump being arranged to supply a hydraulic pressure selectively to the first pressure chamber and the second pressure chamber; a first hydraulic passage including a portion made from an elastomer, and connecting the first pressure chamber of the power cylinder and the first outlet port of the reversible pump; a second hydraulic passage including a portion made from an elastomer, and connecting the second pressure chamber of the power cylinder and the second outlet port of the reversible pump; a motor arranged to drive the reversible pump; a motor control section configured to output a drive signal to the motor in accordance with a steering assist force applied to the steered wheels; a pump reverse rotation judging section configured to judge a reverse rotation state of the reversible pump when an actual rotation direction of the reversible pump does not correspond to a direction in which the motor is rotated by the driving signal from the motor control section; and a damping torque adding section configured to damp a torque generated in the reversible pump when the pump reverse rotation judging section determines the reverse rotation state of the reversible pump.

According to another aspect of the invention, a control method for a power steering apparatus including a power cylinder including first and second pressure chambers, the power cylinder being arranged to assist a steering force of a steering mechanism connected with steered wheels, a reversible pump including a first outlet port and a second outlet port, the reversible pump being arranged to supply a hydraulic pressure selectively to the first pressure chamber and the second pressure chamber, a first hydraulic passage including a portion made from an elastomer, and connecting the first pressure chamber of the power cylinder and the first outlet port of the reversible pump, a second hydraulic passage including a portion made from an elastomer, and connecting the second pressure chamber of the power cylinder and the second outlet port of the reversible pump, a motor arranged to drive the reversible pump, the control method comprises: a motor controlling step of outputting a drive signal to the motor in accordance with a steering assist force applied to the steered wheels; a pump reverse rotation judging step of judging a reverse rotation state of the reversible pump when an actual rotation direction of the reversible pump does not correspond to a direction in which the motor is rotated by the driving signal from the motor control section; and a damping torque adding step of damping a torque generated in the reversible pump when the pump reverse rotation judging section determines the reverse rotation state of the reversible pump.

### BRIEF DESCRIPTION OF THE DRAWINGS

FIG. 1 is a system configuration diagram showing a power steering apparatus according to the present invention.

FIG. 2 is a control block diagram showing a control unit 100 of the power steering apparatus according to a first embodiment of the present invention.

FIG. 3 is a circuit diagram showing a switching circuit 30.

FIG. 4 is a view showing a current flow in power running state of a motor M.

FIG. 5 is a view showing a current flow in regeneration state of motor M.

FIG. 6 is a schematic view when a second hydraulic passage 22 is pressurized.

FIG. 7 is a schematic view when a first hydraulic passage 21 is pressurized after second hydraulic passage 22 is pressurized.

FIG. 8 is a schematic view when a pump P rotates in the reverse direction after first hydraulic passage 21 is pressurized.

FIG. 9 is a view showing variations of a steering reaction force, and right and left pressures (first and second cylinder pressures) at the reverse rotation of the pump in case of a steel pipe.

FIG. 10 is a view showing variations of a steering reaction force, and right and left pressures (first and second cylinder pressures) at the reverse rotation of the pump in case of a short resin pipe.

FIG. 11 is a view showing variations of a steering reaction force, and right and left pressure (first and second cylinder pressures) at the reverse rotation of the pump in case of a long resin pipe.

FIG. 12 is a time chart when pump P rotates in the reverse direction.

FIG. 13 is a time chart of a steering reaction force in a case in which a damping torque is not provided in a power steering apparatus according to a comparative example.

FIG. 14 is a time chart of a steering reaction force in a case in which a damping torque is provided in the power steering apparatus according to the present invention.

FIG. 15 is a control block diagram showing a control unit 100 of a power steering apparatus in a first variation according to the first embodiment of the present invention.

FIG. 16 is a time chart in the power steering apparatus of FIG. 15.

FIG. 17 is a control block diagram showing a control unit 100 of a power steering apparatus in a second variation according to the first embodiment of the present invention.

FIG. 18 is a control block diagram showing a gradual reduction processing section 170 of the power steering apparatus of FIG. 17.

FIG. 19 is a time chart in the power steering apparatus of FIG. 17.

FIG. 20 is a control block diagram showing a control unit 100 according to a second embodiment of the present invention.

FIG. 21 is a control block diagram showing a control unit 100 in a variation according to the second embodiment of the present invention.

FIG. 22 is a control block diagram showing a control unit 100 of a power steering apparatus according to a third embodiment of the present invention.

FIG. 23 is a control block diagram showing a control unit 100 of a power steering apparatus according to a fourth embodiment of the present invention.

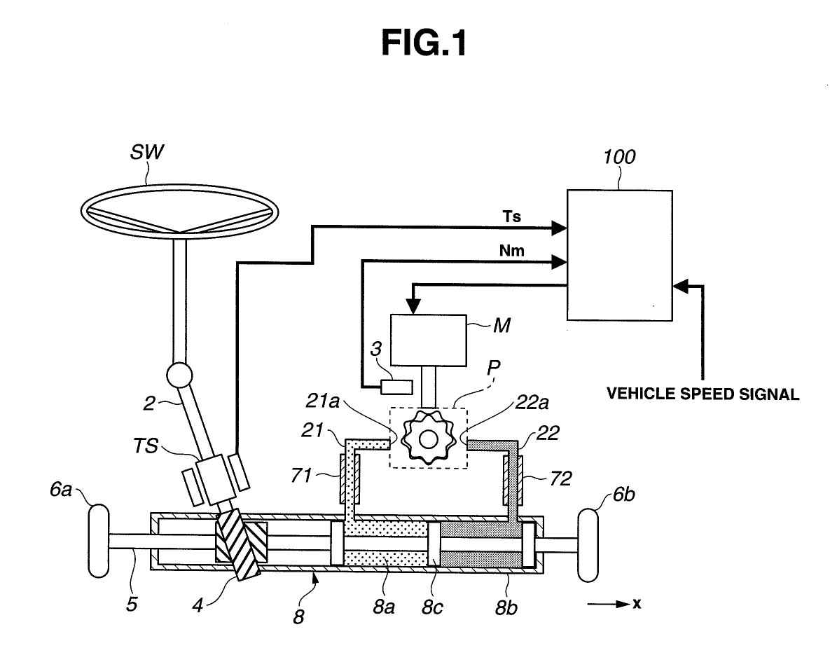

### DETAILED DESCRIPTION OF THE INVENTION

[System Configuration of Power Steering Apparatus] FIG. 1 is a view showing a power steering apparatus according to the present invention. An x-axis is defined by an axial direction of a rack shaft 5. A positive side of the x-axis is defined by a side of a second cylinder 8b of a power cylinder 8.

When a driver steers a steering wheel SW, a pinion 4 is driven through shaft 2. A rack shaft 5 is moved in the axial direction by a rack and pinion mechanism (steering mechanism), and front wheels or steered wheels 6a and 6b are steered. A torque sensor TS is provided to shaft 2. Torque sensor TS is arranged to sense a steering torque of a driver, and to output a torque signal to a control unit (motor control section) 100.

Rack shaft 5 is provided with a power steering mechanism arranged to assist movement of rack shaft 5 in accordance with the steering torque of the driver. This power steering apparatus includes a reversible pump P driven by a motor M; and a power cylinder 8 arranged to move rack shaft 5 in left and right directions.

This pump P includes a first port 21a and a second port 22a (first and second outlet or discharge ports). Power cylinder 8 includes a piston 8c located within power cylinder 8, and arranged to be moved in the axial direction. This piston 8c defines a first cylinder chamber 8a and a second cylinder chamber 8b (first and second pressure chambers).

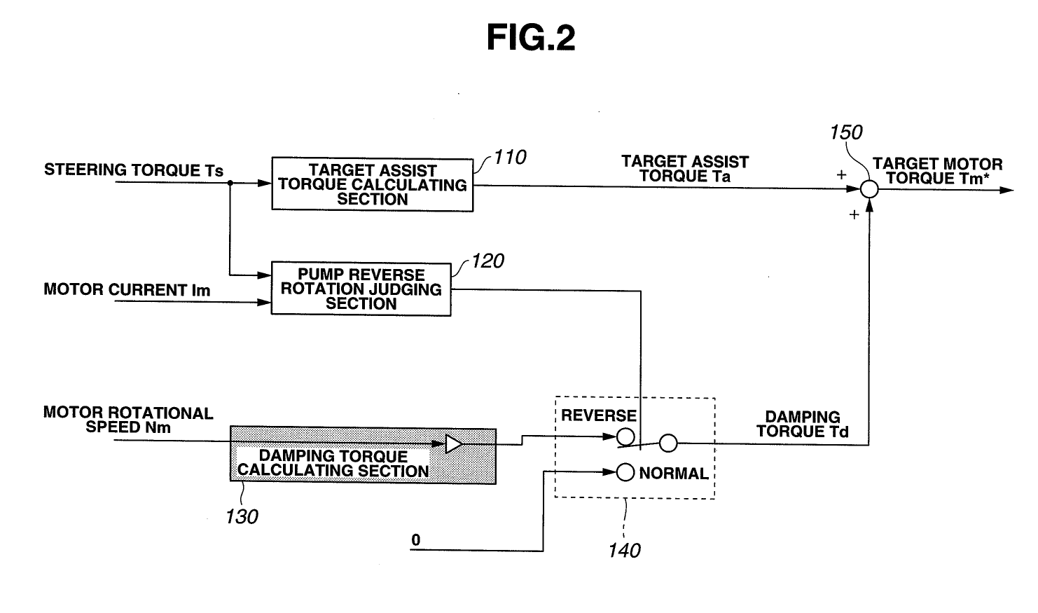

Control unit 100 receives a steering torque Ts from torque sensor TS, a rotational speed signal Nm of motor M sensed by a motor rotational speed sensor 3, and a vehicle speed signal and so on. An assist torque Ta is a command signal of motor M (cf. FIG. 2). Assist torque Ta is determined only by steering torque Ts, and outputted irrespective of an actual motor torque Tm and a rotational direction of pump P.

First and second hydraulic passages 21 and 22 include, respectively, resin pipes or conduits 71 and 72 made from synthetic resin. In this way, a part of first hydraulic passage 21 and a part of second hydraulic passage 22 are made from the synthetic resin, and accordingly it is possible to improve layout of the pipe, and to stabilize the controllability of by decreasing the pulsation of the hydraulic pressure.

In a case in which assist torque Ta is not resisted (opposed) against a reaction force from rack shaft 5, a movement direction of rack 5 may be in a right steered direction although steering torque TS is in the leftward direction (for example, when rack shaft 5 is moved by a pressure difference between first and second cylinders 8a and 8b). In this case, the direction of assist torque Ta is opposite to the actual rotational direction of motor M, and pump P rotates in a direction opposite to the direction of assist torque Ta.

Accordingly, when the reverse rotation of pump P is sensed, assist torque Ta is increased to suppress the reverse rotation of pump P. A damping torque Td is added to assist torque Ta to increase assist torque Ta, as shown in FIG. 2.

[Control Block Diagram] FIG. 2 is a control block diagram showing a control unit 100. Control unit 100 includes a target assist torque calculating section 110, a pump reverse rotation judging section 120, a damping torque calculating section 130, and a damping torque adding section or damping torque providing section 140.

Target assist torque calculating section 110 is configured to calculate target assist torque Ta based on steering torque Ts, and to output target assist torque Ta to an adding section 150. Pump reverse rotation judging section 120 is configured to judge whether pump rotates in a normal (forward) rotation or in a reverse rotation, based on a direction of an electric current (rotation) of motor M and a direction of steering torque Ts, and to output the judgment result to damping torque adding section 140.

Damping torque calculating section 130 is configured to calculate damping torque Td based on motor rotational speed Nm, and to output damping torque Td to damping torque adding section 140. This damping torque Td is for adding the torque in the normal or forward direction so as to dissolve the reverse rotation when the actual rotation directions of pump P and motor M are opposite to the drive command value.

The calculation of damping torque Td may be by multiplying a predetermined correction coefficient to motor rotational speed Nm, or may employ another method. Moreover, damping torque Td has a magnitude that the rotational speed identical to the rotational speed of motor M is caused in the reverse direction.

Damping torque adding section 140 is configured to switch whether or not to add (provide) the damping torque Td in accordance with the judgment result of pump reverse rotation judging section 120. Damping torque adding section 140 is configured so as not to add damping torque Td (Td=0) when the actual rotation direction of pump P is in the normal direction with respect to the pump drive command. Damping torque adding section 140 is configured to output the calculated damping torque Td to adding section 150 when the actual rotation direction of pump P is in the reverse direction with respect to the pump drive command.

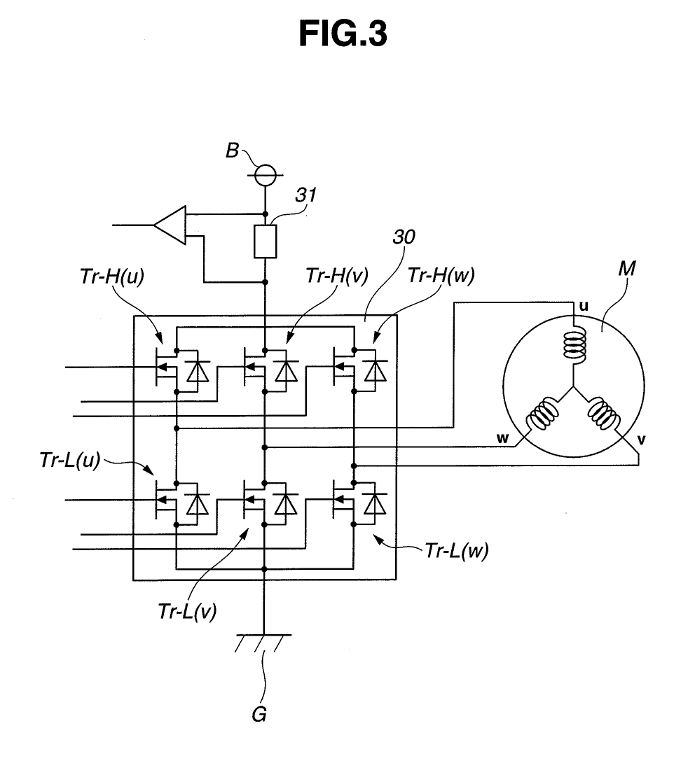

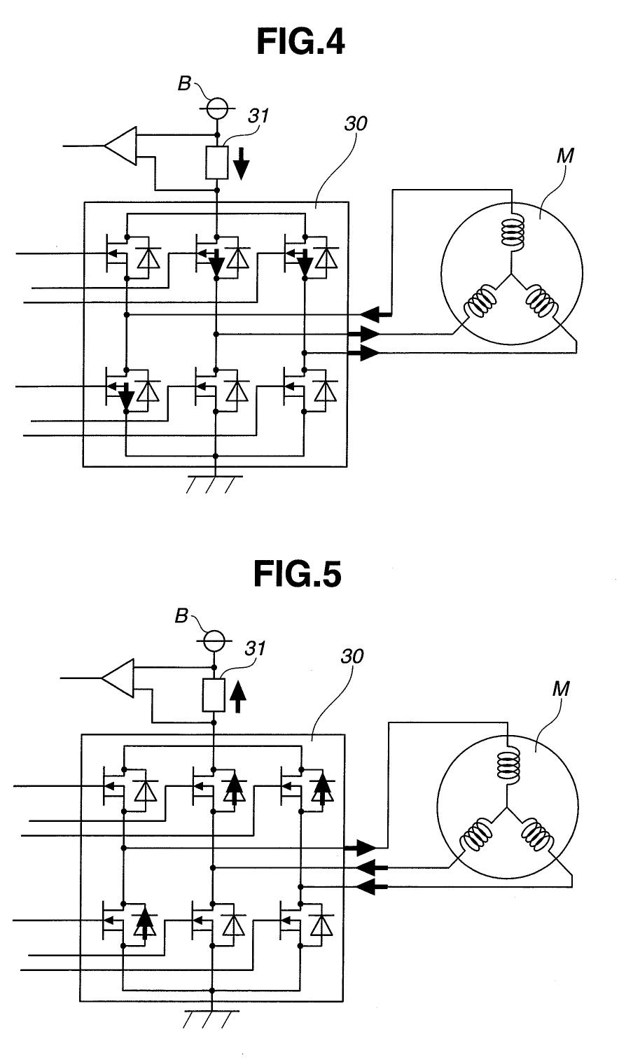

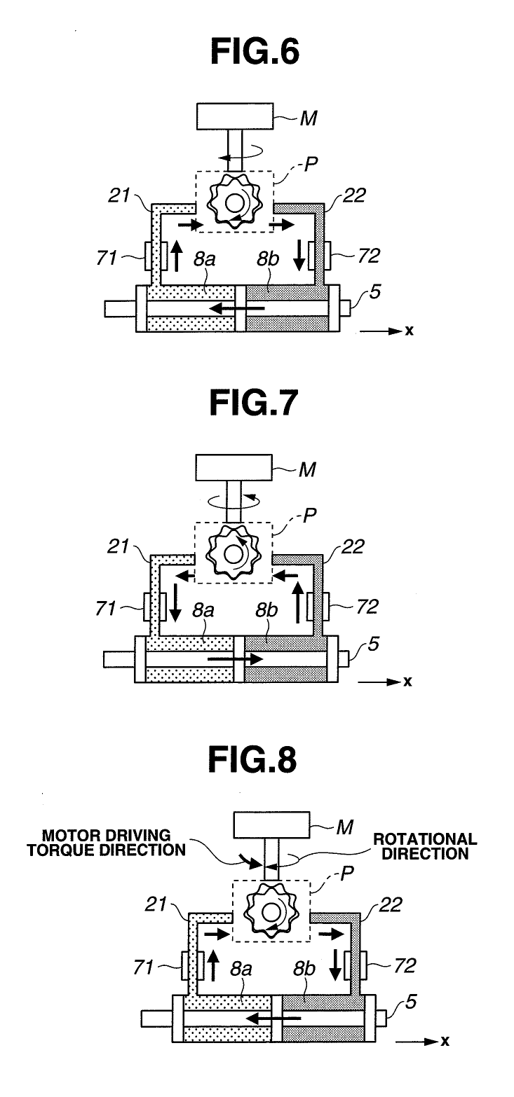

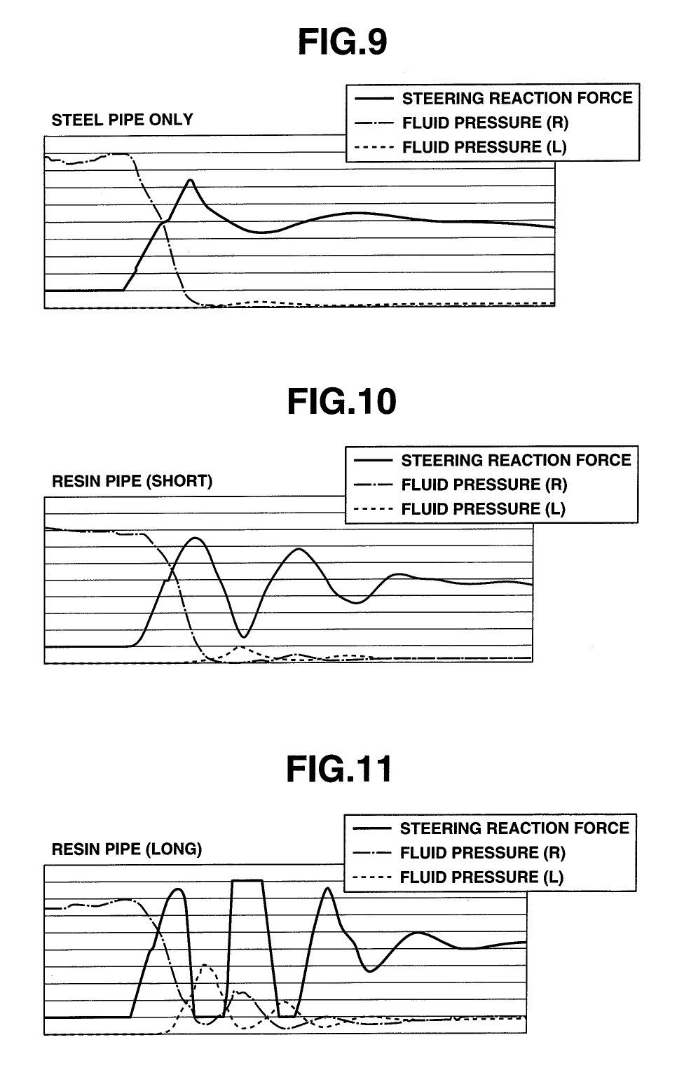

Adding section 150 is configured to add target assist torque Ta and damping torque Td, and to output as a target motor torque Tm*.

[Switching Circuit] FIG. 3 is a circuit diagram showing a switching circuit 30. FIG. 4 is a view showing a current flow in the power running state of motor M. FIG. 5 is a view showing a current flow in the regeneration state of motor M. Switching circuit 30 includes six transistors. Each of phases u, v and w is provided with a transistor Tr on a high side (a power supply B) and a transistor Tr on a low side (a ground G), as shown in FIG. 3. Between power supply B and switching circuit 30, there is provided a current sensing section 31 configured to sense whether the current flow is in a direction to drive motor M, or in a direction in which the regeneration current is generated by motor M, and to output the result to control unit 100.

[Power Running State (Normal Rotation) and Regeneration State (Reverse Rotation) of Motor] FIG. 4 is a view showing the current flow between motor M and switching circuit 30 in the power running state (the normal rotation) of motor M. FIG. 5 is a view showing the current flow between motor M and switching circuit 30 in the regeneration state (the reverse rotation) of motor M. At the normal rotation, the current flows from power supply B to motor M to become the power running state. At the reverse rotation, the current flows from motor M to power supply B by the electric power generation to become the regeneration state. The current direction is sensed by current sensing section 31, and outputted to control unit 100.

[Damping Torque Adding Control at Pump Reverse Rotation] FIGS. 6-8 show schematic views showing mechanism of the reverse rotation of the pump. FIG. 6 is a view when second hydraulic passage 22 is pressurized (when the steering wheel is steered in the left direction). FIG. 7 is a view when first hydraulic passage 21 is pressurized after the state of FIG. 6 (when the steering wheel is steered in the right direction). FIG. 8 is a view showing a state in which pump P rotates in the reverse direction after first hydraulic passage 21 is pressurized. FIGS. 9˜11 are views showing variations of the steering reaction force, and the left and right pressures (the first and second cylinder pressures). FIG. 9 is a view showing variations of the steering reaction force and the left and right pressures (the first and second cylinder pressures) in the reverse rotation state of the pump in the case of a steel pipe. FIG. 10 is a view showing variations of the steering reaction force and the left and right pressures (the first and second cylinder pressures) in the reverse rotation state of the pump in the case of a short resin pipe. FIG. 11 is a view showing variations of the steering reaction force and the left and right pressures (the first and second cylinder pressures) in the reverse rotation state of the pump in the case of a long resin pipe.

When first hydraulic passage 21 is pressurized, pump P is driven in a direction to supply the hydraulic fluid to the first hydraulic passage 21. When second hydraulic passage 22 is pressurized, pump P is driven in a direction to supply the hydraulic fluid to the second hydraulic passage 22. After the first and second hydraulic passages 21 and 22 are pressurized, pump P tends to rotate by the pressure difference in a direction opposite to the previous rotation direction. In a case in which the torque in the normal (forward) direction of pump P does not resist or oppose the pressure difference (for example, in the hand free state and so on), pump P rotates in the reverse direction. This reverse rotation is transmitted to steering wheel SW, and the driver feels the unnatural (unpleasant) feeling.

In particular, hydraulic passages 21 and 22 include, respectively, pipes 71 and 72 made from the resin. Accordingly, when the pipe on the high pressure side which inflates at the assist is retracted, the pipe on the high pressure side promotes the flow to the low pressure side. Pump P rotates in the reverse direction, and the pressures of first and second cylinders 8a and 8b are vibrated (oscillated). This vibration increases the effect on the steering reaction force (FIGS. 9˜11). The vibration increases as pipe 71 and 72 are longer.

In this example, when the reverse rotation of pump P is sensed, the torque in the normal rotation direction (damping torque Td) is provided (added) to motor M to prevent the reverse rotation of pump P (cf. FIG. 2). Accordingly, it is possible to decrease the unnatural feeling of the driver. Pump P and motor M are directly connected with each other, and accordingly it is possible to sense the reverse rotation of pump P by motor rotational speed sensor 3.

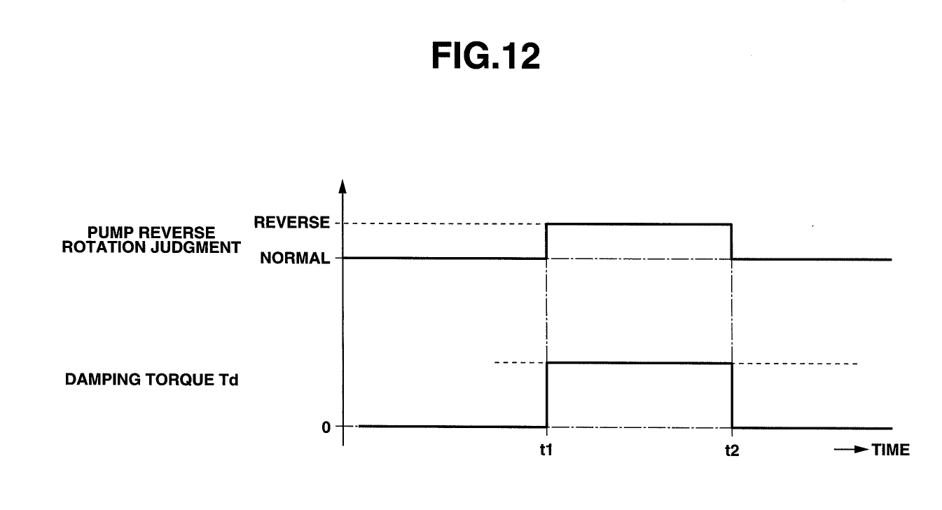

FIG. 12 is a time chart at the reverse rotation of pump P. When it judges the reverse rotation of pump P at time ta, damping torque adding section 140 switches to the adding of the damping torque Td. When it judges the normal rotation of pump P at time t2, damping torque adding section 140 switches to the non-add of the damping torque.

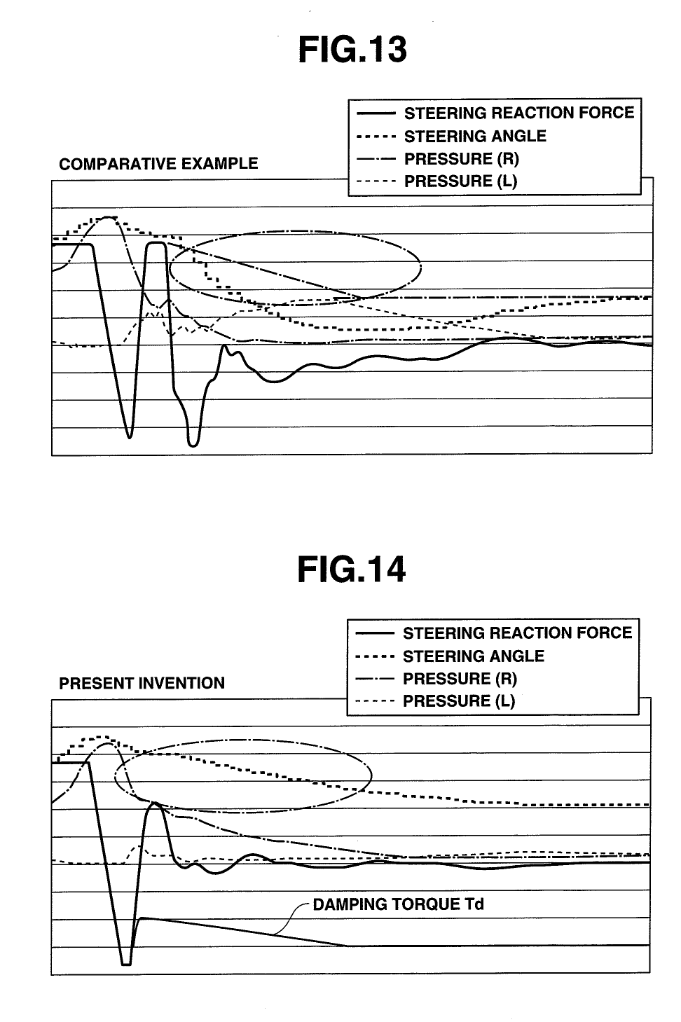

FIG. 13 is a time chart showing the steering reaction force and the pressures of the left and right cylinders (first and second cylinders 8a and 8b) when damping torque Td is not added in the power steering apparatus according to the comparative example. FIG. 14 is a time chart showing the steering reaction force and the left and right cylinders (first and second cylinders 8a and 8b) pressures when damping torque Td is added in the power steering apparatus according to the present invention. By adding damping torque Td, it is possible to suppress the vibrations of first and second cylinder chambers 8a and 8b, and thereby to decrease unnatural feelings to the driver.

The power steering apparatus according to the embodiment of the present invention includes a power cylinder 8 including first and second pressure chambers (8a,8b), the power cylinder 8 being arranged to assist a steering force of a steering mechanism connected with steered wheels (6a,6b); a reversible pump P including a first outlet port 21a and a second outlet port 21b, the reversible pump 3 being arranged to supply a hydraulic pressure selectively to the first pressure chamber 8a and the second pressure chamber 8b; a first hydraulic passage 21 including a portion 71 made from an elastomer, and connecting the first pressure chamber 8a of the power cylinder 8 and the first outlet port 21a of the reversible pump 3; a second hydraulic passage 22 including a portion 72 made from an elastomer, and connecting the second pressure chamber 8b of the power cylinder 8 and the second outlet port 22a of the reversible pump 3; a motor M arranged to drive the reversible pump 3; a motor control section 100 configured to output a drive signal to the motor M in accordance with a steering assist force applied to the steered wheels (6a,6b); a pump reverse rotation judging section 120 configured to judge a reverse rotation state of the reversible pump P when an actual rotation direction of the reversible pump P does not correspond to a direction in which the motor M is rotated by the driving signal from the motor control section 100; and a damping torque adding section 140 configured to damp a torque generated in the reversible pump P when the pump reverse rotation judging section 120 determines the reverse rotation state of the reversible pump P.

The damping torque is added to reversible pump P in the reverse rotation state of reversible pump P, and accordingly it is possible to suppress the reverse rotation state of pump P. Consequently, it is possible to suppress the redundant torque transmitted to steering wheel SW, and to improve the steering feeling.

In the power steering apparatus according to the embodiment of the present invention, the motor M is controlled by a switching circuit 30 configured to control the rotation of the motor M; and the pump reverse rotation judging section 120 is configured to judge the rotation direction of the reversible pump P by a direction of a current flowing between a power supply B and the switching circuit 30.

The pump rotation direction is judged by the direction of the current, and accordingly it is possible to surely stably sense the rotation direction, relative to sensing by using a differential value of the current and so on.

In the power steering apparatus according to the embodiment of the present invention, the damping signal has a magnitude that a rotational speed identical to the rotational speed of the motor M is generated in a direction opposite to the rotation of the motor M.

In the power steering apparatus according to the embodiment of the present invention, the motor M is controlled by a switching circuit 30 configured to control the rotation of the motor M; and the damping torque adding section is configured to damp the rotation of the motor by short-circuiting phases of the switching circuit 30.

When switching circuit 30 is short-circuited, the counter electromotive force is generated in motor M to be brought to the electric brake state. The brake force of the electric brake is proportional to the motor rotational speed, and accordingly it is possible to obtain an appropriate brake force in accordance with the rotational speed.

Hereinafter, a first variation of the first embodiment will be illustrated.

### FIRST VARIATION OF FIRST EMBODIMENT

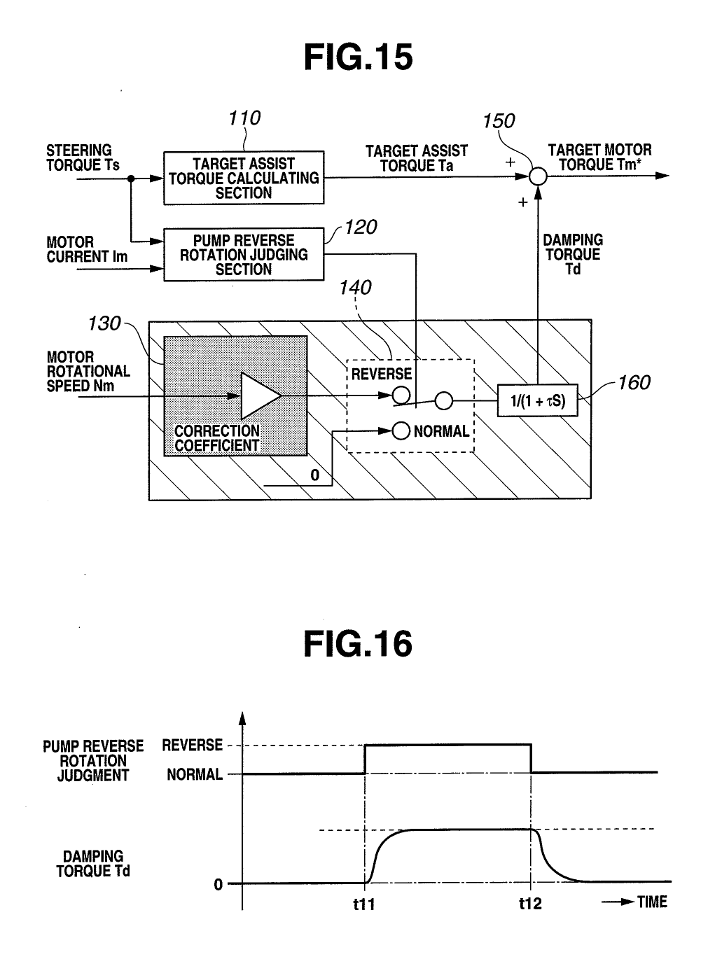

FIG. 15 is a view showing a control block diagram in a case in which control unit 100 performs an integral control at the output of damping torque Td. FIG. 16 is a time chart when the damping torque is added.

In this examples, there is provided an integral control section 160 between damping torque adding section 140 and adding section 150 to perform the integral control. A time constant T of integral control section 160 is predetermined. Accordingly, the torque variation when damping torque Td starts to increase at time t11 and the torque variation when damping torque Td start to decrease at time t12 are stably varied or converged, as shown in FIG. 6.

In the power steering apparatus according to the embodiment of the present invention, the damping signal is calculated based on a value of integral of a rotational speed of the motor M. Accordingly, it is possible to stably converge the reverse rotation of the motor by using the value of the integral.

### SECOND VARIATION OF FIRST Embodiment

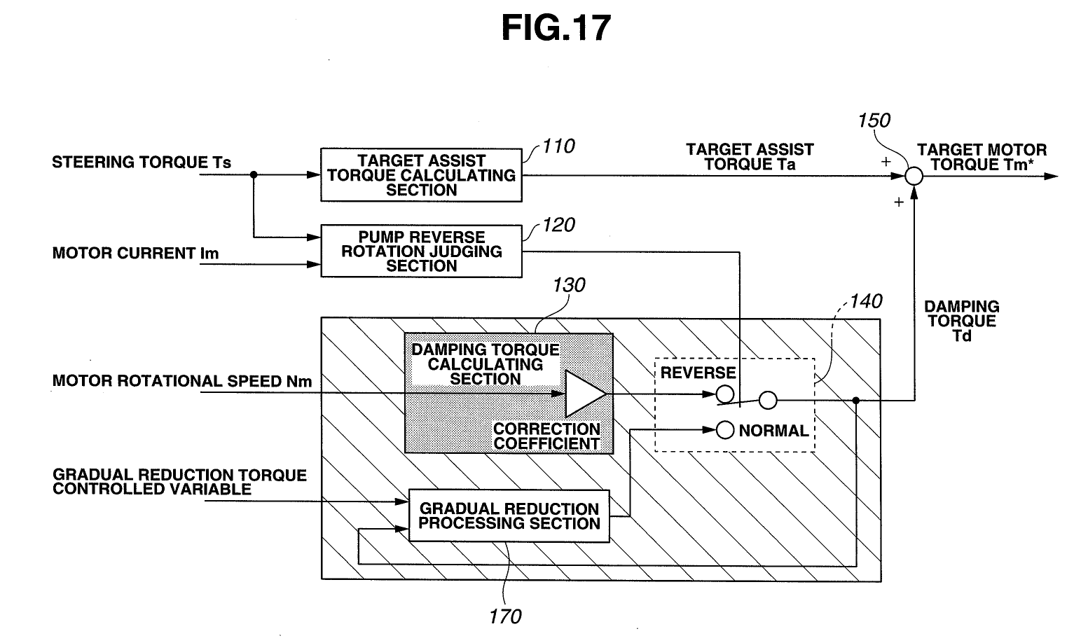

FIG. 17 is a control block diagram showing a control unit 100 of a power steering apparatus in a second variation according to the first embodiment of the present invention. In the first embodiment, damping torque Td is instantly set to zero when pump P is changed from the reverse rotation to the normal rotation. In this second variation of the first embodiment, damping torque Td is gradually decreased when pump P is changed from the reverse rotation to the normal rotation.

In the control block diagram of FIG. 17, there is provided a gradual reduction processing section 170 disposed in parallel with damping torque calculating section 130, and arranged to output a gradual reduction signal to damping torque adding section 140 when pump P rotates in the normal rotation direction. In this case, damping torque Td is gradually decreased based on the predetermined gradual reduction torque, and outputted.

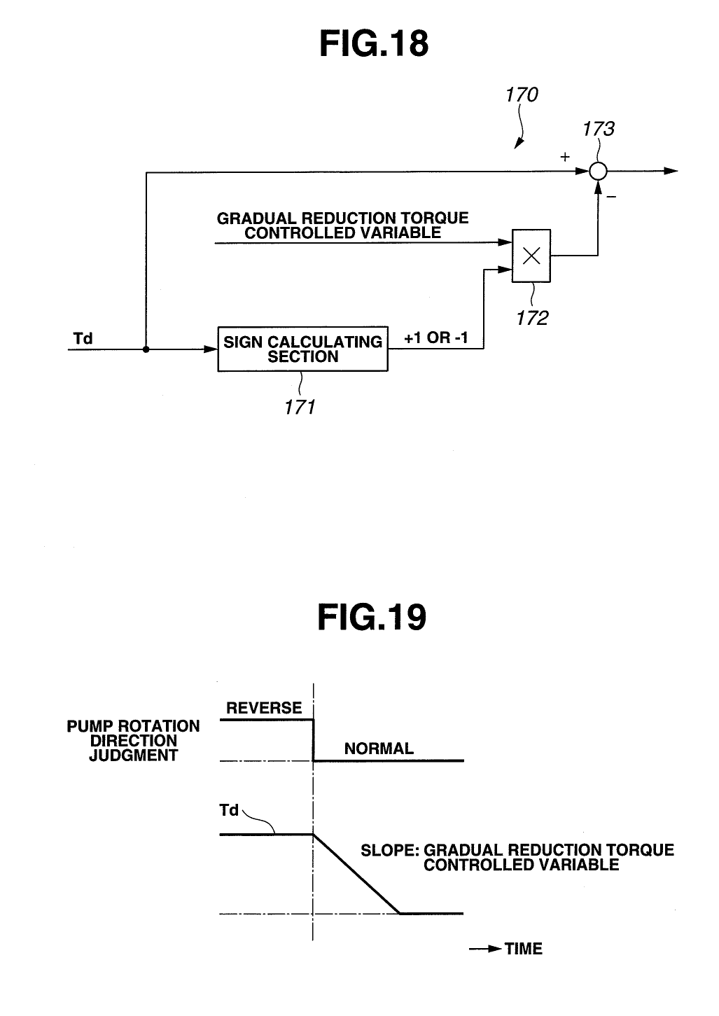

FIG. 18 is a control block diagram showing gradual reduction processing section 170. A sign calculating section 171 is configured to calculate a sign of damping torque Td, to output +1 to a multiplication section 172 when the sign of damping torque Td is plus (+), and to output −1 to multiplication section 172 when the sign of damping torque Td is minus (−). The sign outputted to multiplication section 172 and a gradual reduction torque controlled variable are multiplied, and a difference between this product and damping torque Td is calculated in adding section 173, and outputted.

FIG. 19 is a time chart when pump P is changed from the reverse rotation to the normal rotation in the second variation of the first embodiment. In the second variation of the first embodiment, damping torque Td does not become zero suddenly when pump P is changed from the reverse rotation to the normal rotation, like the first embodiment. Target motor torque Tm* is not suddenly varied with respect to motor M. Accordingly, the variation of the motor torque is gradually converged to target assist torque Ta, and the rotation of motor M is stably converged.

In the power steering apparatus according to the embodiment of the present invention, the damping torque adding section 140 is configured to provide a damping signal to the motor so as to damp the rotation of the motor M. Accordingly, it is possible to accurately converge the reverse rotation of the motor by damping based on the rotation of the motor.

### SECOND EMBODIMENT

Hereinafter, a second embodiment will be illustrated. The basic structure of the second embodiment is identical to the structure of the first embodiment. In the first embodiment, the normal/reverse rotation of pump P is judged based on the direction of the current of motor M and the steering torque direction. In this second embodiment, the pump reverse rotation is determined when the sign of the steering torque sensed by torque sensor TS is different from the sign of the variation of this steering torque.

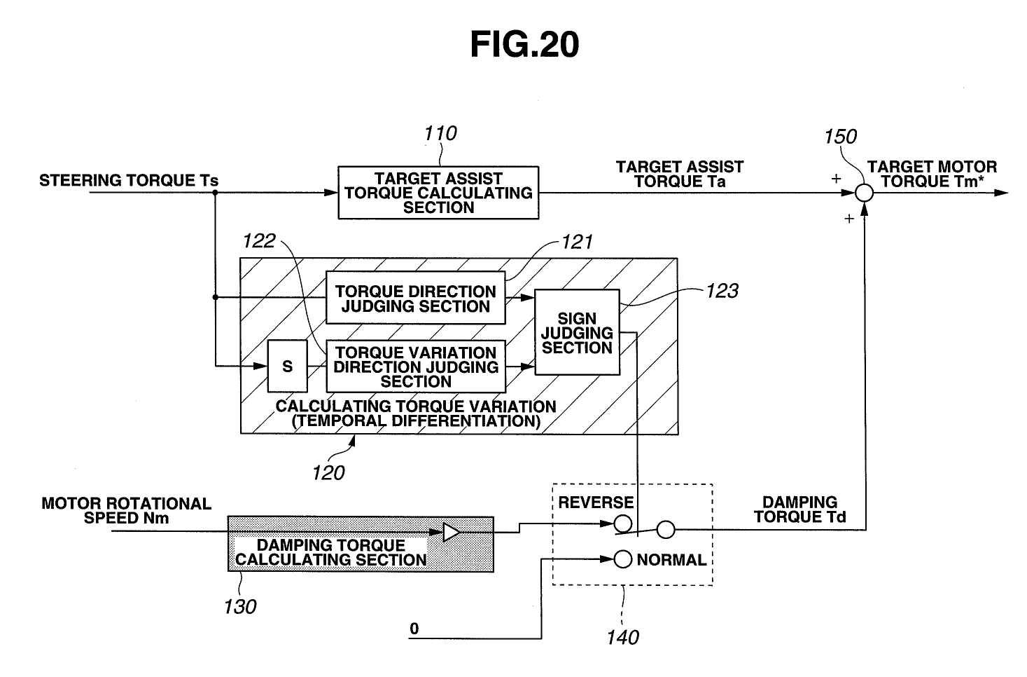

FIG. 20 is a control block diagram showing control unit 100 in the second embodiment. Pump reverse rotation judging section 120 includes a torque direction (sign) judging section 121, a torque variation direction (sign) judging section 122, and a sign judging section 123. Pump reverse rotation judging section 120 is configured to judge accord or disaccord between the sign of the inputted steering torque Ts and the sign of the differential value of the inputted steering torque Ts. In case of the accord, damping torque adding section 140 does not add damping torque Td (Td=0). In case of the disaccord, damping torque adding section 140 adds damping torque Td.

In the power steering apparatus according to the embodiment of the present invention, the power steering apparatus further includes a torque sensing section TS configured to sense a torque generated in the steering mechanism; and the pump reverse rotation judging section 120 is configured to determine the reverse rotation state of the reversible pump P when a sign of the torque sensed by the torque sensing section TS does not correspond to a sign of variation of the torque sensed by the torque sensing section TS. Accordingly, it is possible to readily judge the pump reverse rotation state.

In the power steering apparatus according to the embodiment of the present invention, the torque sensing section TS is a torque sensor TS configured to sense the torque generated in the steering mechanism. Accordingly, it is possible to judge the drag rotation state of the motor (pump) without another structure, by using the torque sensor TS originally provided in the power steering apparatus.

### VARIATION OF SECOND EMBODIMENT

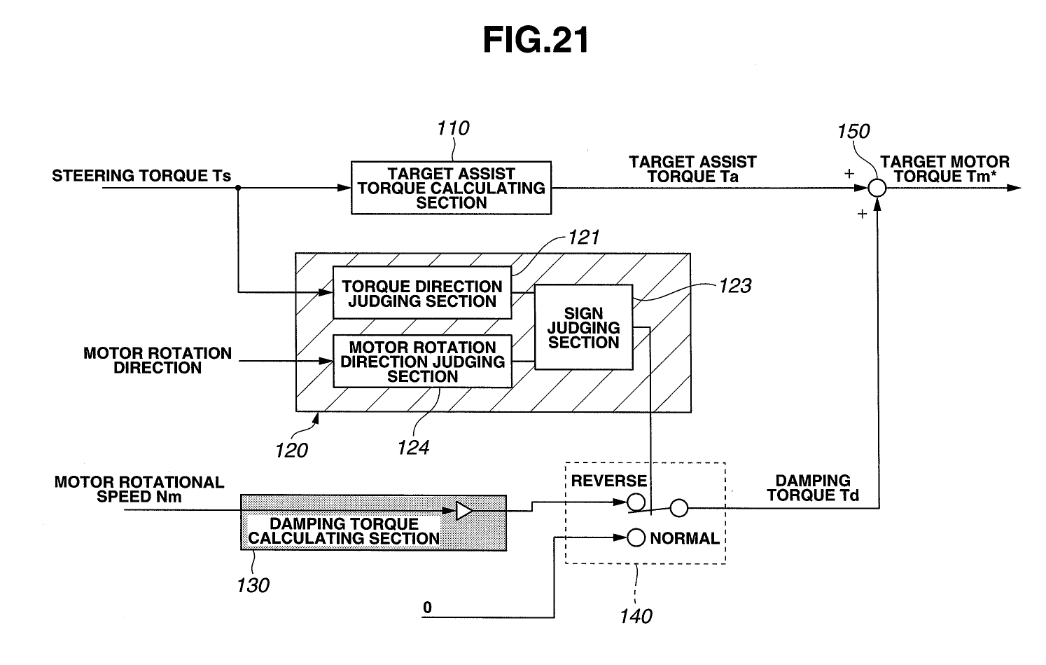

FIG. 21 is a control block diagram showing a control unit 100 in the variation according to the second embodiment. In this variation of the second embodiment, the pump reverse rotation is judged based on the disaccord between the sign of steering torque Ts and the rotation direction of motor M. A motor rotation (rack movement) direction (sign) judging section 124 judges the rotation direction of motor M. Sign judging section 123 judges the accord or the disaccord. Accordingly, it is possible to readily sense the pump reverse rotation state.

Hereinafter, a third embodiment will be illustrated. The basic structure of the third embodiment is identical to the structure of the first embodiment. In the first embodiment, the pump reverse rotation is judged based on the motor rotation direction and the direction of steering torque Ts. In this third embodiment, the pump reverse rotation is judged based on comparison between the motor rotation direction and the pressures within first and second cylinders 8a and 8b.

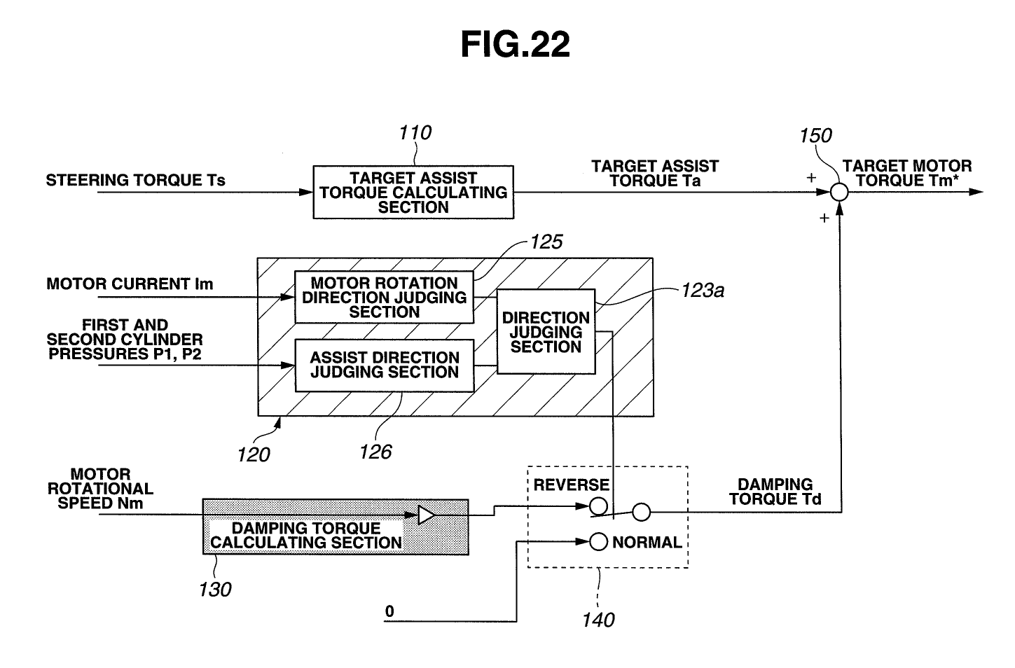

FIG. 22 is a control block diagram showing control unit 100 in a third embodiment. Motor rotation direction judging section 125 judges the rotation direction of motor M based on motor current Im. Assist direction judging section 126 judges a present steering assist direction based on a pressure difference between first and second cylinders 8a and 8b.

Direction judging section 123a judges the accord or the disaccord of the motor rotation direction and the assist direction. In case of the accord, damping torque Td is set to zero (Td=0). In case of the disaccord, damping torque Td is added.

In the power steering apparatus according to the embodiment of the present invention, the pump reverse rotation judging section 120 is configured to judge the reverse rotation state of the reversible pump P by comparing the hydraulic pressure generated in the power cylinder 8 and the rotation direction of the motor M.

The hydraulic pressure generated in power cylinder 8 is transmitted through steering wheel SW to the driver as the steering feeling. The pump reverse rotation is judged based on the hydraulic pressure directly affecting on the steering feeling. Accordingly, it is possible to further improve the steering feeling.

### FOURTH EMBODIMENT

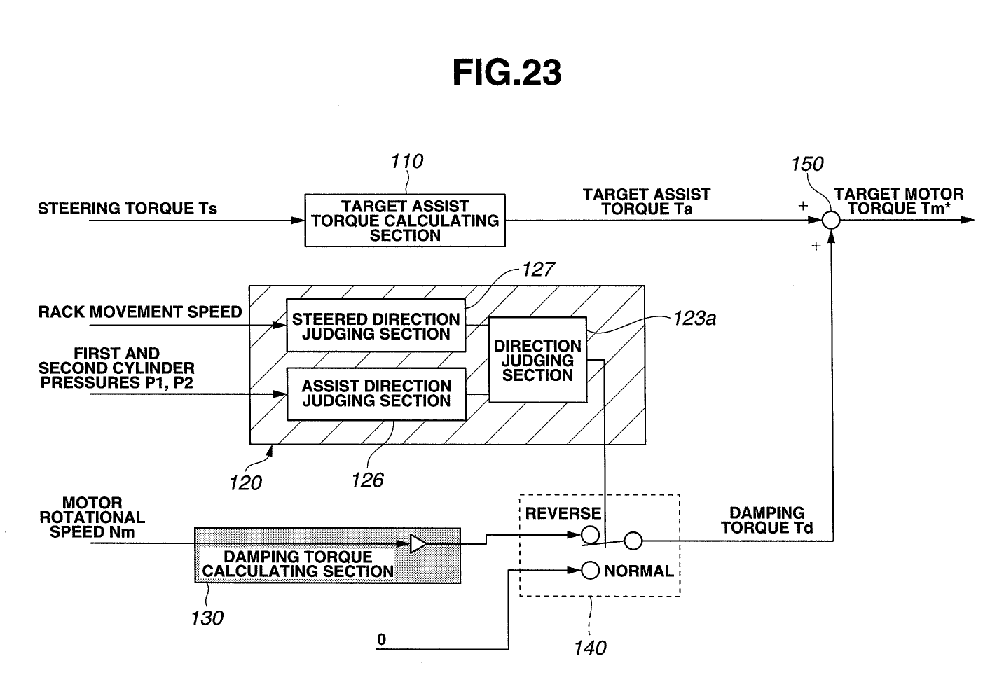

Hereinafter, a fourth embodiment will be illustrated. In the fourth embodiment, the pump reverse rotation is judged by comparison of the steered direction of steered wheels 6a and 6b and the pressures of first and second cylinders 8a and 8b. FIG. 23 is a control block diagram in the fourth embodiment. Steered direction judging section 127 judges the steered direction based on the movement speed of rack shaft 5. Direction judging section 123a judges the accord or the disaccord by comparison between the assist direction and the steered direction to determine the provision/non-provision of damping torque Td.

In the power steering apparatus according to the embodiment of the present invention, the pump reverse rotation judging section is configured to judge the reverse rotation state of the reversible pump by comparing a steered direction of the steered wheels and the hydraulic pressure generated in the power cylinder. Accordingly, it is possible to further improve the steering feeling since the hydraulic pressure generated in power cylinder 8 is transmitted through steering wheel SW to the driver as the steering feeling.

This application is based on a prior Japanese Patent Application No. 2007-292792. The entire contents of the Japanese Patent Application No. 2007-292792 with a filing date of Nov. 12, 2007 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A power steering apparatus comprising:
a power cylinder including first and second pressure chambers, the power cylinder being arranged to assist a steering force of a steering mechanism connected with steered wheels;
a reversible pump including a first outlet port and a second outlet port, the reversible pump being arranged to supply a hydraulic pressure selectively to the first pressure chamber and the second pressure chamber;
a first hydraulic passage including a portion made from an elastomer, and connecting the first pressure chamber of the power cylinder and the first outlet port of the reversible pump;
a second hydraulic passage including a portion made from an elastomer, and connecting the second pressure chamber of the power cylinder and the second outlet port of the reversible pump;
a motor arranged to drive the reversible pump;
a motor control section configured to output a drive signal to the motor in accordance with a steering assist force applied to the steered wheels;
a pump reverse rotation judging section configured to judge a reverse rotation state of the reversible pump when an actual rotation direction of the reversible pump does not correspond to a direction in which the motor is rotated by the driving signal from the motor control section; and
a damping torque adding section configured to damp a torque generated in the reversible pump when the pump reverse rotation judging section determines the reverse rotation state of the reversible pump.

2. The power steering apparatus as claimed in claim 1, wherein the power steering apparatus further comprises a torque sensing section configured to sense a torque generated in the steering mechanism; and the pump reverse rotation judging section is configured to determine the reverse rotation state of the reversible pump when a sign of the torque sensed by the torque sensing section does not correspond to a sign of variation of the torque sensed by the torque sensing section.

3. The power steering apparatus as claimed in claim 2 wherein the torque sensing section is a torque sensor configured to sense the torque generated in the steering mechanism.

4. The power steering apparatus as claimed in claim 1, wherein the motor is controlled by a switching circuit configured to control the rotation of the motor; and the pump reverse rotation judging section is configured to judge the rotation direction of the reversible pump by a direction of a current flowing between a power supply and the switching circuit.

5. The power steering apparatus as claimed in claim 1, wherein the pump reverse rotation judging section is configured to judge the reverse rotation state of the reversible pump by comparing the hydraulic pressure generated in the power cylinder and the rotation direction of the motor.

6. The power steering apparatus as claimed in claim 1, wherein the pump reverse rotation judging section is configured to judge the reverse rotation state of the reversible pump by comparing a steered direction of the steered wheels and the hydraulic pressure generated in the power cylinder.

7. The power steering apparatus as claimed in claim 1, wherein the damping torque adding section is configured to provide a damping signal to the motor so as to damp the rotation of the motor.

8. The power steering apparatus as claimed in claim 7, wherein the damping signal is calculated based on a value of integral of a rotational speed of the motor.

9. The power steering apparatus as claimed in claim 7, wherein the damping signal has a magnitude that a rotational speed identical to the rotational speed of the motor is generated in a direction opposite to the rotation of the motor.

10. The power steering apparatus as claimed in claim 7, wherein the motor is controlled by a switching circuit configured to control the rotation of the motor; and the damping torque adding section is configured to damp the rotation of the motor by short-circuiting phases of the switching circuit.

11. A control method for a power steering apparatus including a power cylinder including first and second pressure chambers, the power cylinder being arranged to assist a steering force of a steering mechanism connected with steered wheels, a reversible pump including a first outlet port and a second outlet port, the reversible pump being arranged to supply a hydraulic pressure selectively to the first pressure chamber and the second pressure chamber, a first hydraulic passage including a portion made from an elastomer, and connecting the first pressure chamber of the power cylinder and the first outlet port of the reversible pump, a second hydraulic passage including a portion made from an elastomer, and connecting the second pressure chamber of the power cylinder and the second outlet port of the reversible pump, a motor arranged to drive the reversible pump, the control method comprising:
a motor controlling step of outputting a drive signal to the motor in accordance with a steering assist force applied to the steered wheels;
a pump reverse rotation judging step of judging a reverse rotation state of the reversible pump when an actual rotation direction of the reversible pump does not correspond to a direction in which the motor is rotated by the driving signal from the motor control section; and
a damping torque adding step of damping a torque generated in the reversible pump when the pump reverse rotation judging section determines the reverse rotation state of the reversible pump.

12. The control method as claimed in claim 11, wherein the power steering apparatus further comprises a torque sensing section configured to sense a torque generated in the steering mechanism; and the pump reverse rotation judging step is configured to determine the reverse rotation state of the reversible pump when a sign of the torque sensed by the torque sensing section does not correspond to a sign of variation of the torque sensed by the torque sensing section.

13. The control method as claimed in claim 12, wherein the torque sensing section is a torque sensor configured to sense the torque generated in the steering mechanism.

14. The control method as claimed in claim 11, wherein the motor is controlled by a switching circuit configured to control the rotation of the motor; and the pump reverse rotation judging step is configured to judge the rotation direction of the reversible pump by a direction of a current flowing between a power supply and the switching circuit.

15. The control method as claimed in claim 11, wherein the pump reverse rotation judging step is configured to judge the reverse rotation state of the reversible pump by comparing the hydraulic pressure generated in the power cylinder and the rotation direction of the motor.

16. The control method as claimed in claim 11, wherein the pump reverse rotation judging step is configured to judge the reverse rotation state of the reversible pump by comparing a steered direction of the steered wheels and the hydraulic pressure generated in the power cylinder.

17. The control method as claimed in claim 11, wherein the damping torque adding step is configured to provide a damping signal to the motor so as to damp the rotation of the motor.

18. The control method as claimed in claim 17, wherein the damping signal is calculated based on a value of integral of a rotational speed of the motor.

19. The control method as claimed in claim 17, wherein the damping signal has a magnitude that a rotational speed identical to the rotational speed of the motor is generated in a direction opposite to the rotation of the motor.

20. The control method as claimed in claim 17, wherein the motor is controlled by a switching circuit configured to control the rotation of the motor; and the damping torque adding section is configured to damp the rotation of the motor by short-circuiting phases of the switching circuit.
